(19) United States
(12) Patent Application Publication
(10) Pub. No.: US 2015/0151872 A1
(43) Pub. Date: Jun. 4, 2015

(54) RESEALABLE CLOSURES

(71) Applicant: Parkside Flexibles (Europe) Limited, Wakefield (GB)

(72) Inventors: Alan Schofield, Wakefield (GB); Steve McCormick, Wakefield (GB)

(21) Appl. No.: 14/412,980

(22) PCT Filed: Jul. 8, 2013
(86) PCT No.: PCT/EP2013/064393

§ 371 Date: Jan. 5, 2015

(30) Foreign Application Priority Data
Jul. 6, 2012 (GB) 1212083.8

(51) Int. Cl. B65D 5/56; B65D 5/62; B31B 1/25

(52) U.S. Cl. CPC B65D 5/563; B31B 1/25; B65D 5/62

(57) ABSTRACT

A laminate for forming a package is provided. Two layers of the laminate are bonded utilising a pressure sensitive adhesive. Flap areas are cut in the layers of the laminate with cuts in different layers being offset from one another such that the flap areas can be opened and resealed.

### TECHNICAL FIELD

This disclosure relates to packaging technologies, and in particular to the formation of resealable closures in laminate packages.

### BACKGROUND

Laminate materials may be utilized to package a variety of products. Laminates offer a flexible packaging material which can be formed into a range of configurations and with various properties depending on the materials utilised. Laminates can be bonded, heat sealed, and printed making them suitable for use in a wide range of packaging applications.

The provision of a laminate material with a resealable opening is challenging and current methods have drawbacks.

Known resealable laminate packages utilise a separate closure device, such as a zip-lock system, or a laminate material with an opening cut through it over which a label is positioned. The label is attached with pressure sensitive adhesive such that it can be pealed back to expose the opening, and then replaced in position. While providing a resealable opening, such arrangements increase cost and complexity as they require separate components and additional manufacturing processes.

There is a requirement for a laminate packaging system which can provide a resealable opening in a cost-effective and aesthetically attractive manner.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

There is provided a laminate for forming a package, comprising a first layer bonded to a second layer by a pressure sensitive adhesive; a first cut through the first layer, but not through the second layer; a second cut through the second layer, but not through the first layer; wherein the first cut defines a flap area in the first layer and the second cut defines a flap area in the second layer within the flap area in the first layer; and the arrangement of the first and second cuts allows the flap areas of the first and second layers to be lifted together along the first and second cuts to create an opening in the laminate, the first layer separating from the second layer in the peripheral region of the flap in the first area between the first and second cuts.

There is also provided a laminate for forming a package, comprising a first layer bonded to an inner layer by a permanent adhesive; a second layer bonded to the inner layer, on the opposite face of the inner layer to that which the first layer is bonded to, by a pressure sensitive adhesive; a first cut through the first layer and the inner layer, but not through the second layer; a second cut through the second layer, but not through the inner layer or first layer; wherein the first cut defines a flap area in the first layer and inner layer and the second cut defines a flap area in the second layer within the flap area in the first and inner layers; and the arrangement of the first and second cuts allows the flap areas of the first, inner, and second layers to be lifted along the first and second cuts to create an opening in the laminate, the second layer separating from the inner layer in the peripheral region of the flap in the first area between the first and second cuts.

There is also provided a laminate for forming a package, comprising a first layer bonded to an inner layer by a pressure sensitive adhesive; a second layer bonded to the inner layer, on the opposite face of the inner layer to that which the first layer is bonded to, by a permanent adhesive; a first cut through the first layer, but not through the inner layer or second layer; a second cut through the second layer and the inner layer, but not through the first layer; wherein the first cut defines a flap area in the first layer and the second cut defines a flap area in the inner layer and the second layer within the flap area in the first layer; and the arrangement of the first and second cuts allows the flap areas of the first, inner, and second layers to be lifted along the first and second cuts to create an opening in the laminate, the first layer separating from the inner layer in the peripheral region of the flap in the first area between the first and second cuts.

The first and second layers may be are formed of an orientated polypropylene.

The inner layer may be formed of an aluminium foil.

At least one face of the laminate may be coated with a low-temperature adhesive.

The pressure sensitive adhesive may have a grammage in the range of 3-8 microns.

The permanent adhesive may have a grammage in the range of 2-3 microns.

The pressure sensitive adhesive may be patterned to reduce the grammage in an area in which the laminate will be cut.

The grammage may be reduced by 75-90%.

The area may have a width in the range of 2-7mm.

The pressure sensitive adhesive may be patterned in the area between the first and second cuts to leave an area free of pressure sensitive adhesive to form a pull tab.

The cuts may be made by a laser cutter.

There is also provided a method of forming a package, comprising the steps of cutting a web of laminate utilising a laser cutter to obtain a laminate according to any of claims 1 to 9, forming the laminate into a package; and sealing the package utilising an induction sealer.

The preferred features may be combined as appropriate, as would be apparent to a skilled person, and may be combined with any of the aspects of the invention.

### BRIEF DESCRIPTION OF THE DRAWINGS

Embodiments of the invention will be described, by way of example, with reference to the following drawings, in which:

FIG. 1 shows a conventional sheet laminate;

FIG. 2 shows a resealable opening in a sheet laminate;

FIG. 3 shows the opening of FIG. 2 partially opened;

FIG. 4 shows a resealable opening in a sheet laminate;

FIG. 5 shows a resealable opening with a tab;

FIG. 6 shows a resealable opening in a two-layer laminate; and

FIG. 7 shows an example package with a resealable opening.

Common reference numerals are used throughout the figures to indicate similar features.

### DETAILED DESCRIPTION

Embodiments of the present invention are described below by way of example only. These examples represent the best ways of putting the invention into practice that are currently known to the Applicant although they are not the only ways in which this could be achieved. The description sets forth the functions of the example and the sequence of steps for constructing and operating the example. However, the same or equivalent functions and sequences may be accomplished by different examples.

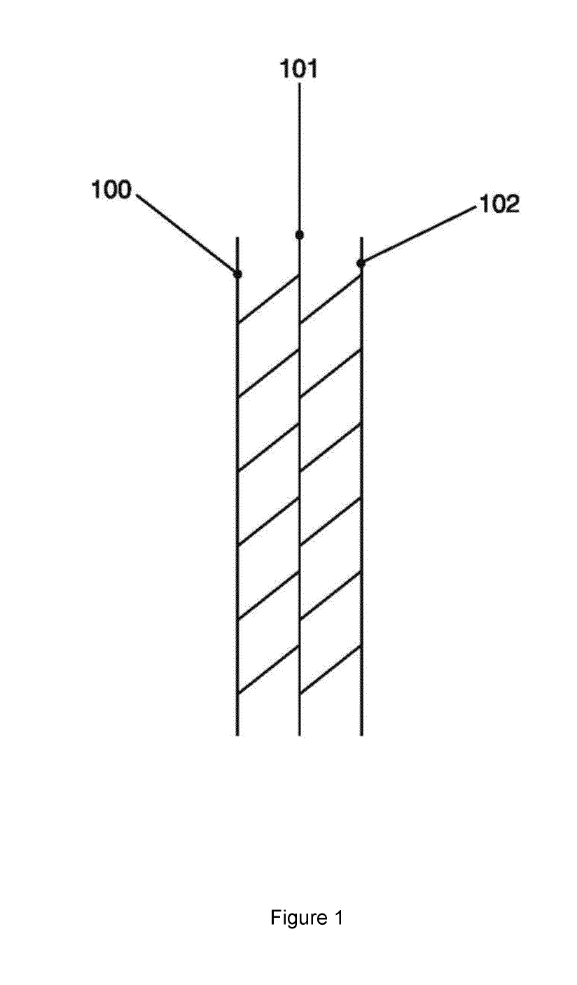

FIG. 1 shows a three-layer laminate suitable for use as a packaging material. A first outer layer 100 is formed of a polymer material, for example 20 micron orientated polypropylene (OPP) and is bonded to an inner layer 101, for example formed of 9 micron Aluminium foil. The inner foil layer 101 is bonded to a second outer layer 102 formed of a polymer material, which may be the same as the first outer layer, or a different polymer material. The triple-laminate structure is advantageous for packaging because it is hermetically sealed and flexible. The layers are laminated together utilising a permanent lamination adhesive.

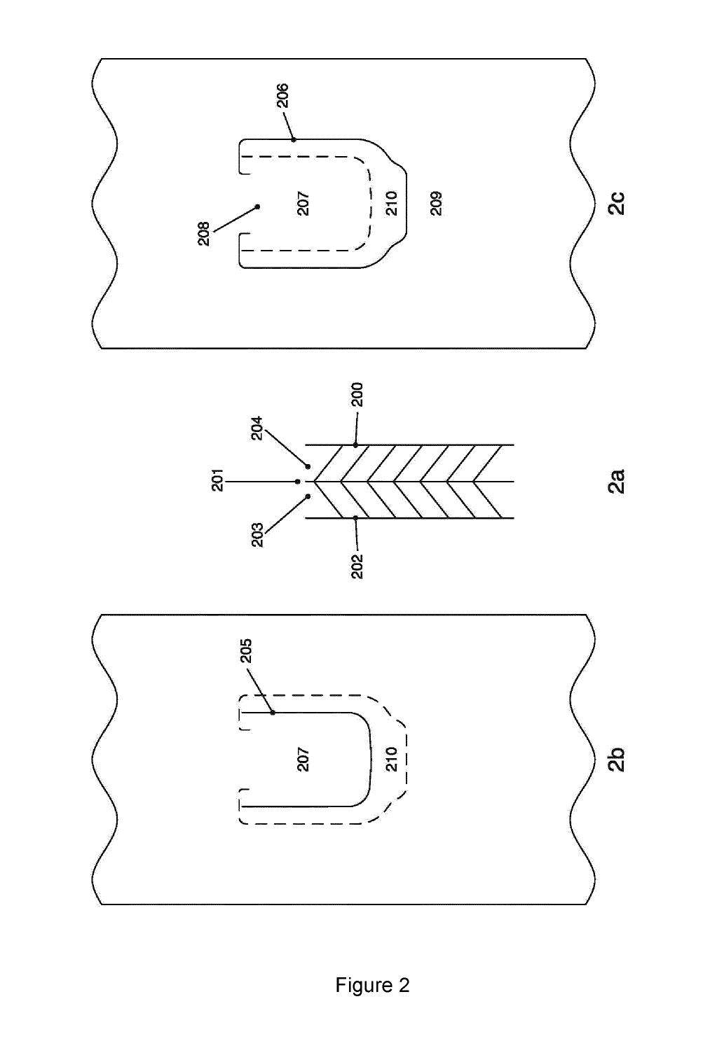

FIG. 2 shows a three-layer 200, 201, 202 laminate material which enables the creation of a resealable opening in a laminate package having comparable properties as the laminate of FIG. 1. The layers may be formed of the same materials as described in relation to FIG. 1, but the inner layer 201 and second outer layer 202 are bonded utilising a Pressure Sensitive Adhesive (PSA) 203, as opposed to the permanent adhesive used in conventional laminates. The first outer layer 200 and inner layer 201 are bonded utilising conventional permanent adhesive 204. In the example of FIGS. 2a and 2b, second outer layer 202 will form the inside of a package formed of the laminate material.

To form a resealable opening a first cut 206 is formed in the first outer layer 200 and inner layer 201. A second cut 205 is formed through the second outer layer 202.

FIG. 2b shows the laminate, after the cuts 205, 206 are formed, from the second outer side (the inside of a package). FIG. 2c shows the laminate, after the cuts 205, 206 are formed, from the first outer side (the outside of a package). The dashed lines indicate the location of cuts 205, 206 where the actual cut is not visible in the particular view as it is through a layer of material which is hidden from view.

The cuts 205, 206 form a flap of laminate material 207 which is unitary with the rest of the sheet 209 along the top edge 208 of the flap. The location of the two cuts 205, 206 defines an overlap region 210 in which layers of the flap extend over layers of the remainder of the package. The central area of the flap 207 is formed of all three layers while the edge of the flap, in the overlap region 210, is formed of inner layer 201 and first outer layer 200. In the overlap region the inner layer 201 of the flap is adhered to the second outer layer 202 which remains part of the rest of the material in that region due to the offset of the two cuts 205, 206.

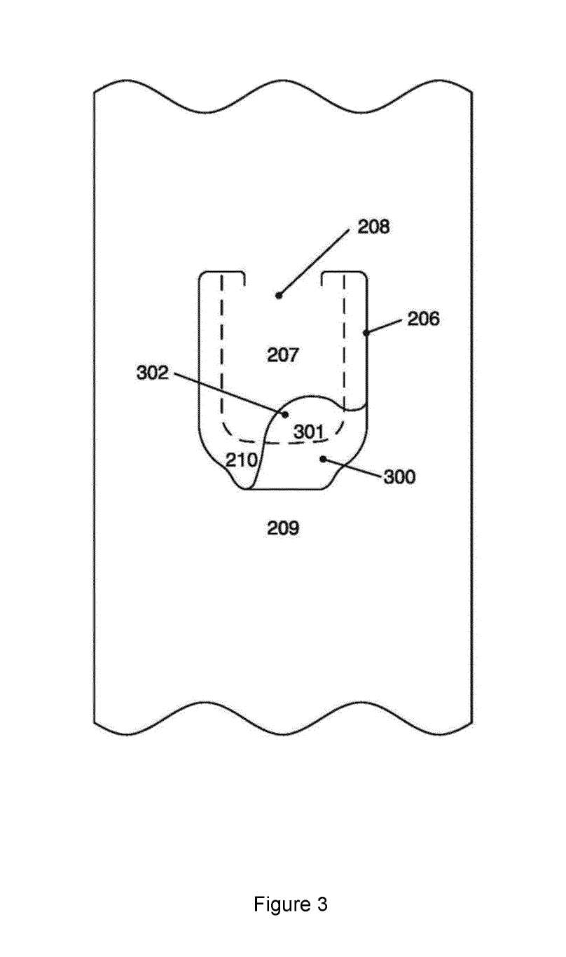

FIG. 3 shows the resealable opening of FIG. 2 in a partially opened position. The flap 207 has been pulled open to separate the overlap region 210. Area 300 therefore comprises the second outer layer 202 The PSA 203 remains adhered to the first inner layer 201 in area 302 as it has a greater affinity for that material than the material of the outer layers. As the flap 207 is opened, an opening 301 is created through the laminate material. The opening 301 may be resealed by pressing the edge region of the flap which carries the PSA on to the exposed area 300 of the second outer layer 202, to return the opening to the configuration shown in FIGS. 2b and 2c. The arrangement of cuts through selected layers and use of a pressure sensitive adhesive between two layers thereby allow the formation of a resealable opening in the laminate material without any additional components.

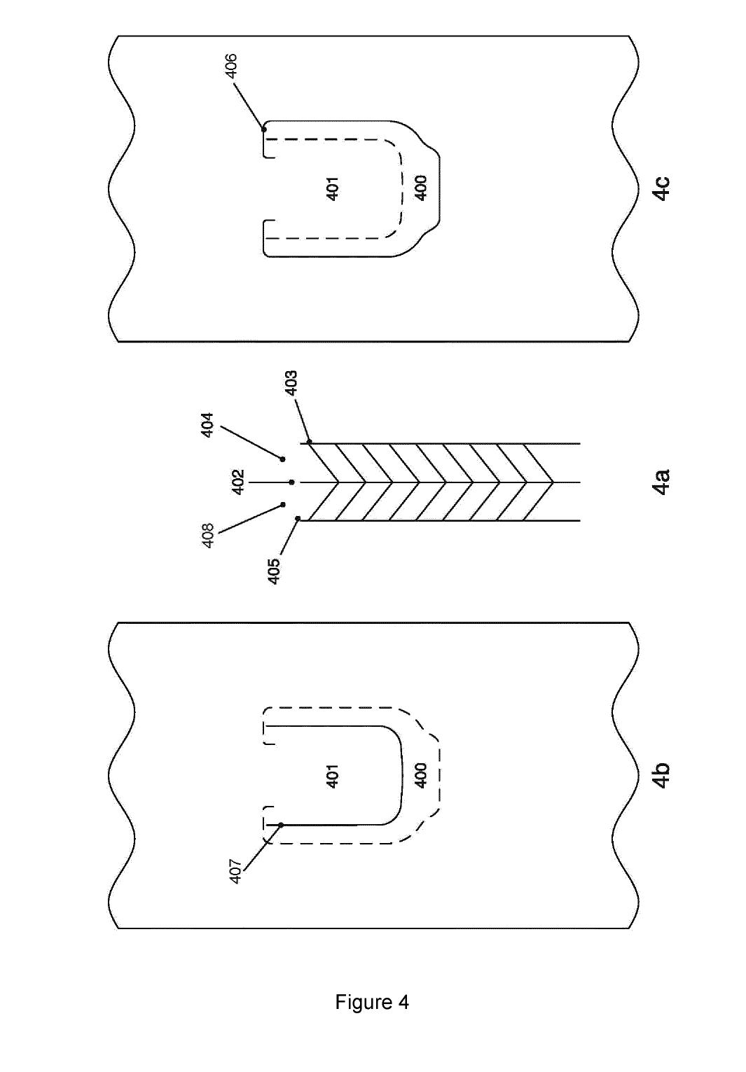

FIG. 4 shows an alternative embodiment in which the edge region 400 of the flap 401 is formed of only an outer layer as opposed to an outer and an inner layer as shown in the embodiment of FIG. 2. FIG. 4a shows a laminate comprising an inner layer 402, which is bonded to a first outer layer 403 by a PSA 404. The inner layer 402 is also bonded to a second outer layer 405 by a permanent adhesive 408.

To form a resealable opening a first cut 406 is formed in the first outer layer 403. A second cut 407 is formed through the second outer layer 405 and the inner layer 402.

FIG. 4b shows the laminate, after cuts 406, 407 are formed, from the second outer side (the inside of a package). FIG. 4c shows the laminate, after the cuts 406, 407 are formed, from the first outer side (the outside of a package). The dashed lines indicate the location of cuts 406, 407 where the actual cut is not visible in the particular view as it is through a layer of material which is hidden from view.

The central region of the flap comprises all three layers 402, 404, 405, but the edge of the flap in the overlap region is only formed of first outer layer 403. The opening of FIG. 4 operates on the same principles as that of FIG. 2, but the separation in the overlap region is between the inner layer remains part of the remainder of the package in the overlap region, not part of the flap. This arrangement may give a different tactile feel to the opening as the edge of the flap will be thinner.

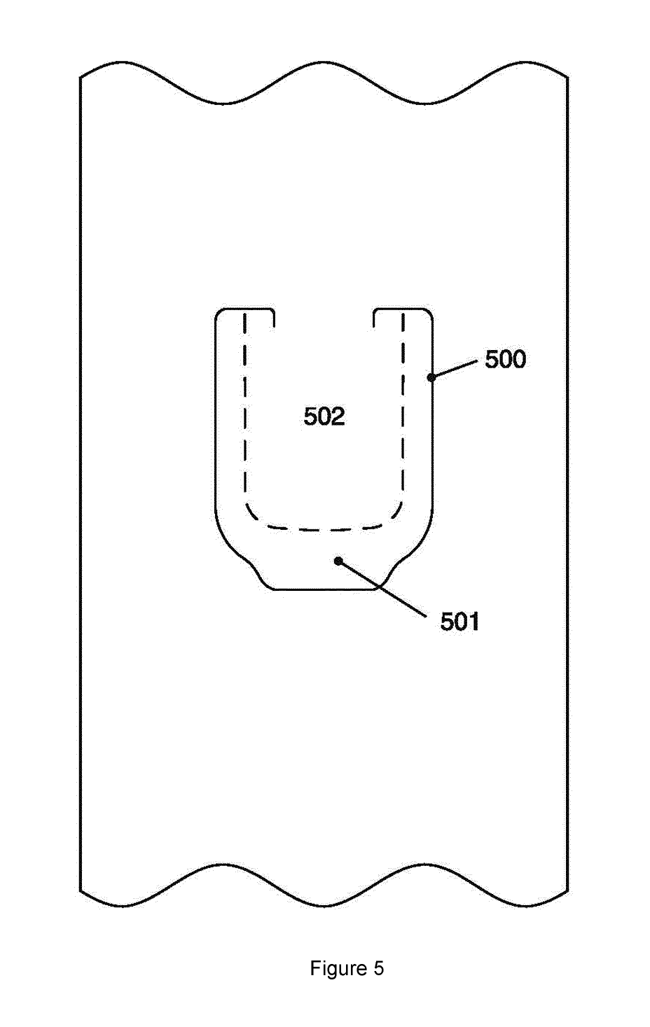

The pressure sensitive adhesive of any embodiments may be patterned to leave areas without any adhesive to make the flap easier to open. In particular, an area in the overlap region 210 may be left without any adhesive. FIG. 5 shows a design of opening in which the outer cut 500 is shaped to provide a pull tab 501. The PSA 203 between the inner layer 201 and the second outer layer 202 is patterned such that the region below the pull tab 501 is free from PSA. The pull tab 501 may therefore be easily lifted up and used to pull open the flap 502.

As will be appreciated the shape and design of the cuts may be varied according to the aesthetic and functional requirements of each design, provided the offset relationship of the first and second cuts is maintained to provide the overlap region 210. For example, different shapes may be utilised according to design, or the curvature and shape of the cuts may be selected to avoid tearing of the materials as the flap is opened. As the cut designs become more complex and/or the dimensions of the cut lines increase the time taken to form the openings may increase.

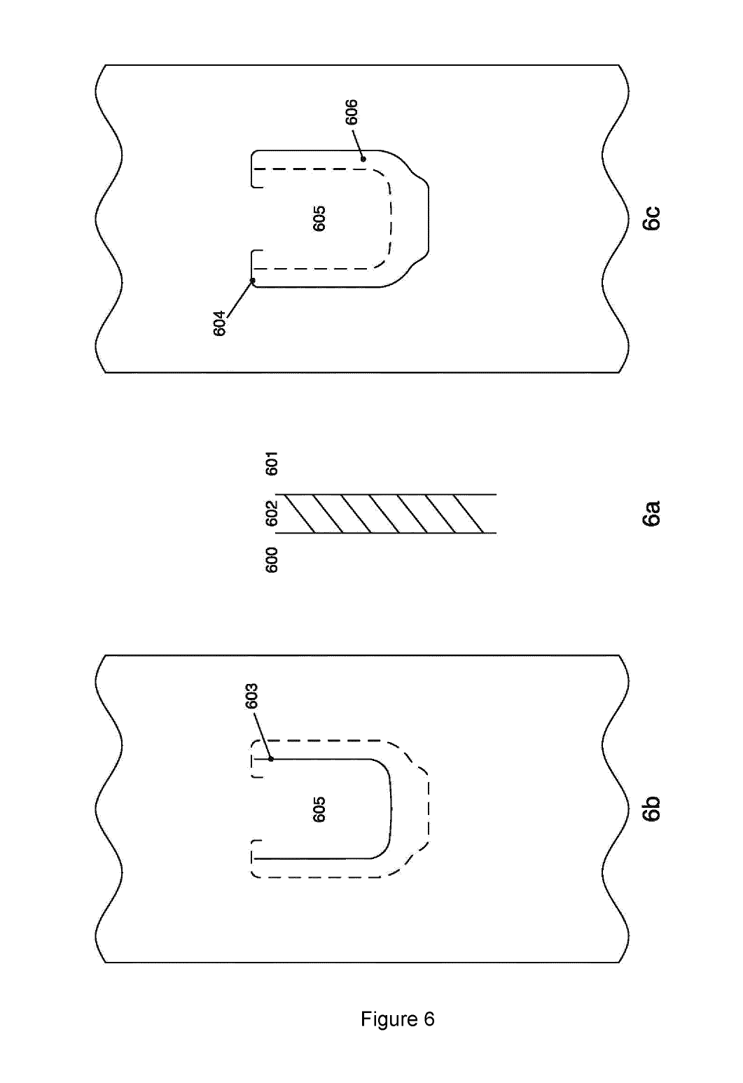

In a variation of the opening described above, a two-layer laminate may be utilised. The principles described above apply in the same way to such a laminate. FIG. 6 shows a two-layer laminate with a resealable opening. First layer 600 is bonded to second layer 601 with a PSA 602.

To form the opening a first cut 603 is made through first layer 600, and a second cut 604 is made through second layer 601. As explained hereinbefore, dashed lines indicate cuts through a layer which is not visible in a particular view. Second layer 601 will form the outside of a package formed from the laminate material.

The resealable opening opens in the same way as the triple-laminate opening described above by pulling the flap 605 open to separate the layers around the overlap region 606. The PSA may be patterned as described hereinbefore to provide a pull-tab, and as noted above the shape and design of the cuts may be varied as required.

The above embodiments have been described in relation to a three- and two-layer laminate, but as will be appreciated any number of layers may be utilised provided two of the layers are bonded with a PSA.

The layers of the laminate material may be selected to provide the desired mechanical and tactile performance. For example, a thicker material may give a better feel to a user opening the flap. Different aspects of the package may require different characteristics, requiring a design compromise to select an appropriate material. For example, the body of the package may preferably have a thicker material to give a more rigid package, whereas the flap may preferably use a thinner material to make opening the closure more tactile. The relative thicknesses of the materials may also affect the performance of the product. For example, thickening a metallic layer will have a different effect to thickening a plastic layer.

The PSA is selected such that a sufficient bond is formed to retain the flap in the closed position, while also allowing the flap to be opened by the application of an appropriate force. Furthermore, since the same layer of PSA retains the layers of the laminate together, the bond must be sufficient to prevent delamination during use. The required bond may be achieved by the selection of an appropriate adhesive, and the amount of that adhesive utilised.

A permanent adhesive grammage of less than 2 grams per square meter (gsm) may lead to a poor aesthetic appearance and air bubbles may form. A permanent adhesive grammage above 3 gsm may cause tubing and curling of the laminate making handling difficult. In an embodiment the permanent adhesive may be applied with a grammage of 2-3 gsm.

A PSA grammage below 3 gsm may cause delamination of the laminate. A grammage above 8 gsm may cause tubing and curling of the laminate. In an embodiment the PSA may be applied with a grammage of 3-8 gsm.

In contrast to permanent adhesives that are typically utilised in lamination, PSAs do not set. During formation of packages from the laminates described herein, it is necessary to cut the sheet into the required shapes. Typically this is performed using a blade or guillotine. Since the PSA does not set, it tends to adhere to the blade, thereby contaminating it and reducing cutting efficiency. To reduce this contamination, the PSA may be patterned to reduce the amount applied in regions where the sheet is to cut. The application of PSA may be reduced by 75-90% in a region of 5 mm centred on the cutting location.

Laminates utilising a metal layer may be formed into packages utilising an inductive sealing technique. At least one outside face of the laminate is provided with a low-temperature sealant which becomes tacky as its temperature is raised, for example above 70° C. The laminate is formed into the required package, and with the surfaces to be bonded in contact with one another, the laminate is passed into an induction sealer. The induction sealer produces a magnetic field through which the package is passed. This induces an electrical charge that is passed through the inner foil layer causing heat to be generated. This heat conducts through the laminate layers to heat the low temperature sealant adhering the material together into the package. The elevated temperature during this sealing process may affect the performance of the PSA, which should be accounted for when selecting an appropriate PSA, materials, and amounts.

An alternative embodiment of FIG. 2 provides a tamper proof package. The second cut 205 is not a continuous cut, but is a perforation, score, or scribed line in layer 202. When the flap is opened for the first time the layer 202 remains in-tact with the remainder of the material due to the perforations. The open flap is formed of the inner layer 201 and the outer layer 200. The user can then open the package by tearing layer 202 along the perforation. The perforation may be on three sides of the flap as shown in FIG. 2, in which case upon tearing the layer is adhered to the inner layer 201 of the open flap because the PSA remains on foil layer . On subsequent openings the second outer layer 202 opens with the flap as described with reference to FIG. 2. In a further alternative, the perforation may be on four sides of the opening area such that the second outer layer within the opening can be totally separated from the package.

A similar tamper proof opening may be formed as an alternative to the embodiment of FIG. 4, by replacing cut 407 with a perforation.

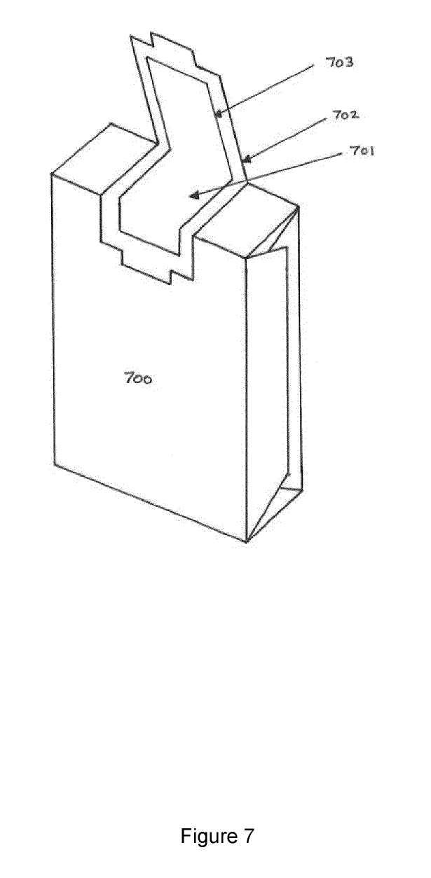

FIG. 7 shows an example package 700 formed of laminate material and comprising a resealable opening 701 as described hereinbefore. The cuts 702, 703 for the opening are formed in a web of the material which is then formed utilising known techniques, for example induction heating, into the package 700.

Conventionally when a package such as that shown in FIG. 7 is utilised an outer wrap is also utilised to provide a tamper-proof seal. However, the provision of a tamper-proof opening described hereinbefore may remove the requirement for the wrap. Furthermore, for certain products such as cigarettes, a laminate package is used a secondary inner package within an outer cardboard package with an outer tamper proof wrap. However, a printed laminate package with a resealable tamper-proof opening may allow the laminate package to be utilised as the only packaging, thereby reducing cost and simplifying the packaging process.

The above example has been given in relation to packaging for cigarettes, but as will be appreciated the same principles apply to packages for any type of product.

The resealable closures described hereinbefore may be formed by cutting a laminate material using lasers. In relation to FIG. 2, a first laser may be utilised to make the first cut 206 through the outer layer 200 from that side of the laminate. A second laser may be utilised to continue the first cut 206 through the inner metallic layer. Different lasers are typically required for these layers since the differing material require different cutting lasers operating at wavelengths which cause heating of the particular material. Typically the wavelength required to cut the outer and inner layers is different. The second cut 205 may be made from the other side of the material by a third laser. Cutting the first and second cuts from differing sides of the laminate material allows the formation of the cuts through only a limited number of the layers, as required by the resealable closure design.

Other cutting techniques may be utilised as appropriate, for example the cuts may be formed in the layers prior to lamination, or different cutting technologies may be used.

It will be understood that the benefits and advantages described above may relate to one embodiment or may relate to several embodiments. The embodiments are not limited to those that solve any or all of the stated problems or those that have any or all of the stated benefits and advantages.

In the above description the term Pressure Sensitive Adhesive (PSA) has been used in the context of an adhesive that will adhere two surfaces, but allow their separation and later re-adherence. It is not intended to restrict the type of adhesive, but only as a description of function.

Any reference to an item refers to one or more of those items. The term ‘comprising’ is used herein to mean including the method blocks or elements identified, but that such blocks or elements do not comprise an exclusive list and a method or apparatus may contain additional blocks or elements.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

It will be understood that the above description of a preferred embodiment is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the spirit or scope of this invention.

1. A laminate for forming a package, comprising:
a first layer bonded to a second layer by only a pressure sensitive adhesive;
a first cut through the first layer, but not through the second layer;
a second cut through the second layer, but not through the first layer;
wherein the first cut defines a flap area in the first layer and the second cut defines a flap area in the second layer within the flap area in the first layer; and
the arrangement of the first and second cuts allows the flap areas of the first and second layers to be lifted together along the first and second cuts to create an opening in the laminate, the first layer separating from the second layer in the peripheral region of the flap in the first area between the first and second cuts.

2. A laminate for forming a package, comprising:
a first layer bonded to an inner layer by only a permanent adhesive;
a second layer bonded to the inner layer, on the opposite face of the inner layer to that which the first layer is bonded to, by only a pressure sensitive adhesive;
a first cut through the first layer and the inner layer, but not through the second layer;
a second cut through the second layer, but not through the inner layer or first layer;
wherein the first cut defines a flap area in the first layer and inner layer and the second cut defines a flap area in the second layer within the flap area in the first and inner layers; and
the arrangement of the first and second cuts allows the flap areas of the first, inner, and second layers to be lifted along the first and second cuts to create an opening in the laminate, the second layer separating from the inner layer in the peripheral region of the flap in the first area between the first and second cuts.

3. A laminate for forming a package, comprising:
a first layer bonded to an inner layer by only a pressure sensitive adhesive;
a second layer bonded to the inner layer, on the opposite face of the inner layer to that which the first layer is bonded to, by only a permanent adhesive;
a first cut through the first layer, but not through the inner layer or second layer;
a second cut through the second layer and the inner layer, but not through the first layer;
wherein the first cut defines a flap area in the first layer and the second cut defines a flap area in the inner layer and the second layer within the flap area in the first layer; and
the arrangement of the first and second cuts allows the flap areas of the first, inner, and second layers to be lifted along the first and second cuts to create an opening in the laminate, the first layer separating from the inner layer in the peripheral region of the flap in the first area between the first and second cuts.

4. A laminate according to claim 1, wherein the first and second layers are formed of an orientated polypropylene.

5. A laminate according to claim 1, wherein the inner layer is formed of an aluminium foil.

6. A laminate according to claim 1, wherein at least one face of the laminate is coated with a low-temperature adhesive.

7. A laminate according to claim 1, wherein the pressure sensitive adhesive has a grammage in the range of 3 to 8 grams per square meter.

8. A laminate according to claim 1, wherein the permanent adhesive has a grammage in the range of 2 to 3 grams per square meter.

9. A laminate according to claim 1, wherein the pressure sensitive adhesive is patterned to reduce the grammage in an area in which the laminate will be cut.

10. A laminate according to claim 9, wherein the grammage is reduced by from 75% to 90%.

11. A laminate according to claim 9, wherein the area has a width in the range of 2 to 7 mm.

12. A laminate according to claim 1, wherein the pressure sensitive adhesive is patterned in the area between the first and second cuts to leave an area free of pressure sensitive adhesive to form a pull tab.

13. A laminate according to claim 1, wherein the cuts are made by a laser cutter.

14. A method of forming a package, further comprising:
cutting a web of laminate utilising a laser cutter to obtain a laminate according to claim 1,
forming the laminate into a package; and
sealing the package utilising an induction sealer.
